(19) United States
(12) Patent Application Publication
(10) Pub. No.: US 2024/0289857 A1
(43) Pub. Date: Aug. 29, 2024

(54) DETERMINING ITEM DESIRABILITY TO USERS BASED ON ITEM ATTRIBUTES AND ITEM EXPIRATION DATE

(71) Applicant: Maplebear Inc. (dba Instacart), San Francisco, CA (US)

(72) Inventors: Shaun Navin Maharaj, Vaughan (CA); Brent Scheibelhut, Toronto (CA); Mark Oberemk, Toronto (CA)

(21) Appl. No.: 18/113,874

(22) Filed: Feb. 24, 2023

(51) Int. Cl. G06Q 30/0601

(52) U.S. Cl. CPC G06Q 30/0623; G06Q 30/0603

(57) ABSTRACT

An online concierge system delivers items from multiple retailers to customers. To avoid delivery of expired or near-expired items, the online concierge system obtains attributes of items offered by a retailer, such as from images of items at the retailer from client devices and uses a trained desirability model to predict a desirability score of an item based on the item's attributes. The desirability model is trained using training examples with labels indicating whether an item was suitable for inclusion in an order. The desirability model may be used to determine if an item is suitable for inclusion in an order, to provide suggestions for a retailer for using the item, or to select a retailer for fulfilling an order.

### BACKGROUND

Online concierge systems receive orders for items from customers. To fulfill an order, the online concierge system allocates the order to a picker (or a shopper), who items in an order from a retailer. The picker delivers the obtained items to a customer to fulfill the order. Because a picker obtains items from a retailer, the online concierge system is dependent on items available from the retailer to fulfill orders.

However, items offered by a retailer have expiration dates, and, for various reasons, many retailers are unable to efficiently track expiration dates of items that are offered. This inaccurate tracking of expiration dates of items by retailers may cause a picker to obtain items nearing their expiration dates when fulfilling an order. Similarly, retailers are often inefficient in replacing items near their corresponding expiration dates with items having a longer time until their expiration dates, which may also cause a picker to obtain items nearing their expiration dates when fulfilling an order. Inclusion of items nearing their expiration date when fulfilling an order may discourage a customer placing the order from placing additional orders through the online concierge system or cause the customer to request reimbursement from the online concierge system for items in an order nearing their expiration dates. Additionally, inefficient monitoring of item expiration dates may increase an amount of an item that is unsold by a retailer, increasing an amount of item disposed of by the retailer rather than sold.

### SUMMARY

In accordance with one or more aspects of the disclosure, an online concierge system trains a desirability model that determines a desirability score for an item. The desirability score accounts for an amount of time between determination of the desirability score and an expiration date for the item. To train the desirability model, the online concierge system obtains training examples from users, such as pickers or customers, with each training example including an identifier of an item, one or more images of an item, and a label from a user indicating whether the item is acceptable for inclusion in an order. In some embodiments, the label has a first value indicating the item is suitable for inclusion in an order and has a second, different, value indicating the item is not suitable for inclusion in the order. In other embodiments, the label has a value selected from a range of values, with different values corresponding to different levels of acceptability for inclusion of the item in an order.

The online concierge system extracts attributes of an item in a training example by applying one or more computer vision models to the one or more images of the item in the training example. A training example may include additional attributes of an item in various embodiments. For example, a training example includes an expiration date of the item. In some embodiments, a user who captured the image of the item also identifies the expiration date of the item. Alternatively, the online concierge system determines the expiration date of the item from information received from a retailer. For example, a user specifies a retailer where an image of the item was captured and a date when the image of the item was captured along with the image of the item. From the identifier of the item and the specified retailer, the online concierge system retrieves information associated with the retailer (or from the retailer) identifying a specified expiration date of the item. In other embodiments, the online concierge system extracts an expiration date of the item from the image of the item.

In some embodiments, the online concierge system additionally determines a shelf warming life for an item included in a training example. The shelf warming life of the item measures an amount of time the item has been available at the retailer. For example, the online concierge system determines the shelf warming life for an item included in a training example based on an identifier of a retailer, an identifier of the item, and a time when the training example was obtained. As an example, the online concierge system retrieves data from a retailer (or associated with a retailer) indicating a date when the retailer most recently received the item and determines the shelf warming life for the item based on a difference between the date when the retailer most recently received the item and a date when the online concierge system obtained the image of the item of the training example. The shelf warming life allows the online concierge system to account for an amount of time the retailer has had the item.

Thus, in various embodiments, the online concierge system leverages stored information about an item or information about the item from other sources to include additional attributes of the item in a training example. This allows the online concierge system to augment the one or more images of the item and the label indicating whether the item is acceptable for inclusion in an order in a training example with additional attributes of an item. The additional attributes provide additional information about a length of time the item has been offered or stored by the retailer relative to its expiration date in various embodiments. Further, the additional information allows the online concierge system to better determine an expiration date for the item.

The online concierge system trains the desirability model for the item using a set of training examples including the item. The desirability model receives attributes of the item as inputs and outputs a desirability score for the item. The desirability score provides a likelihood of the item being suitable for inclusion in an order based on attributes of the item. In some embodiments, the desirability score is binary, having a first value indicating the item is suitable for inclusion in an order and having a second value indicating the item is not suitable for inclusion in an order. Alternatively, the desirability score has a range of values, with different values indicating different levels of the item's suitability for inclusion in an order.

The desirability model comprises a set of weights stored on a non-transitory computer readable storage medium of the online concierge system in various embodiments. The weights comprise a set of parameters used by the desirability model to transform input data—the attributes of the item-received by the desirability model into output data—the desirability score. The online concierge system generates the weights by applying the desirability model to a set of training examples, with a label associated with each training example. Application of the desirability model to a training example generates a predicted desirability score for an item included in the training example. The online concierge system compares the predicted desirability score for the training example to a label of the training example. In various embodiments, the online concierge system scores the predicted desirability score from the desirability model using a loss function. The loss function is a function that generates a score for the predicted desirability score where the score is higher when the predicted desirability score is nearer to the label of the training example, while the score is lower when the predicted desirability score is farther from the label of the training example. The online concierge system updates the set of parameters for the desirability model based on the score for the training example through a backpropagation process. In various embodiments, the online concierge system performs the backpropagation process until the loss function satisfies one or more criteria and stores the set of parameters.

The online concierge system stores the trained desirability model in association with the item. In various embodiments, the online concierge system trains and stores different desirability models in association with different items. As different attributes of different items affect a desirability of including different items in orders, different trained models for different items allow the online concierge system to account for effects of different attributes on suitability of inclusion of different items in orders.

Hence, by training and storing a desirability model for different items, the online concierge system accounts for an amount of time until an item's expiration date to optimize use of the item. The online concierge system may use the desirability score for an item in different ways. For example, the online concierge system provides notifications about whether to include an item in an order based on the desirability score of the item. This reduces a likelihood of a picker including an item within a threshold amount of time of its expiration date in an order, increasing a customer's satisfaction with the order. Similarly, the online concierge system may aggregate desirability scores for multiple items to determine a retailer desirability score. The online concierge system selects a retailer for fulfilling an order based on the aggregated desirability scores for retailers, increasing a likelihood of the order being fulfilled by a retailer most likely to have items in the order that are greater than a threshold amount of time from their expiration dates. Additionally, the online concierge system may provide suggestions to a retailer for marketing or using the item to a retailer based on the item's desirability score that minimizes an amount of inventory of the item within the threshold amount of time from its expiration date maintained by the retailer.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates a flowchart of a method for determining a desirability score for an item based on whether the item is nearing expiration, in accordance with one or more embodiments.

FIG. 4 is a flowchart of a method for selecting a retailer for an order based on desirability scores for items by retailers, in accordance with one or more embodiments.

FIG. 5 is a flowchart of a method for an online concierge system providing recommendations to a retailer based on desirability scores of items offered by the retailer, in accordance with one or more embodiments.

FIG. 6 is a process flow diagram of an online concierge system performing one or more actions based on a desirability score determined for an item, in accordance with one or more embodiments.

### DETAILED DESCRIPTION

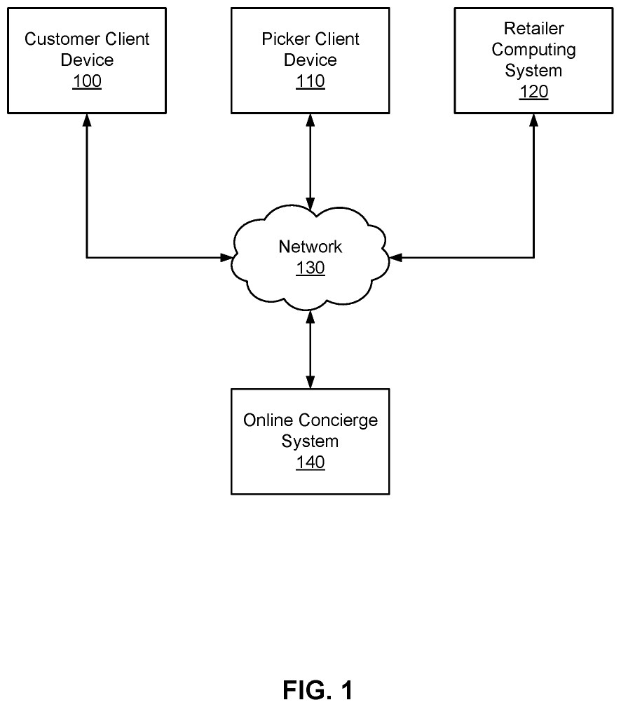

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

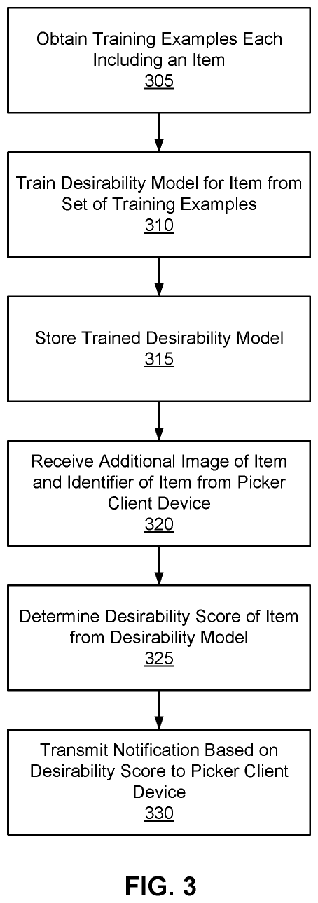

In various embodiments, the picker captures one or more images of an item via the picker client device 110. The picker client device 110 transmits the one or more images of the item to the online concierge system 140, which determines a desirability score for the item, as further described below in conjunction with FIG. 3. In various embodiments, the picker client device 110 receives a notification from the online concierge system 140 based on the desirability score for the item and displays the notification to the picker. For example, the notification is a message that the item is suitable for inclusion in an order or that the item is not suitable for inclusion in an order, allowing the online concierge system 140 provide messages to the picker to increase a likelihood of the picker including items in an order that will satisfy the customer who placed the order.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

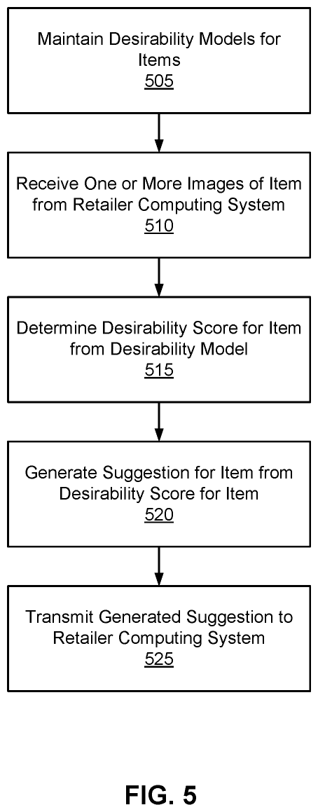

In some embodiments, the retailer computing system 120 captures one or more images of an item offered by the retailer and transmits the images of the item to the online concierge system 140. The retailer computing system 120 may transmit other attributes of the item to the online concierge system 140 as well in some embodiments. The online concierge system 140 determines a desirability score for the item, as further described below in conjunction with FIG. 3. In various embodiments, the retailer computing system 120 receives a suggestion from the online concierge system 140 based on the desirability score for the item and displays the suggestion to one or more users associated with the retailer. For example, the suggestion is a message to offer the item at a discounted price. As another example, the suggestion is a message to reposition the item to a different location in the retailer. In another example, the suggestion is a message to donate the item or to move the item to a different location of the retailer. Suggestions transmitted from the online concierge system 140 to the retailer computing system 120 is further described below in conjunction with FIG. 5.

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

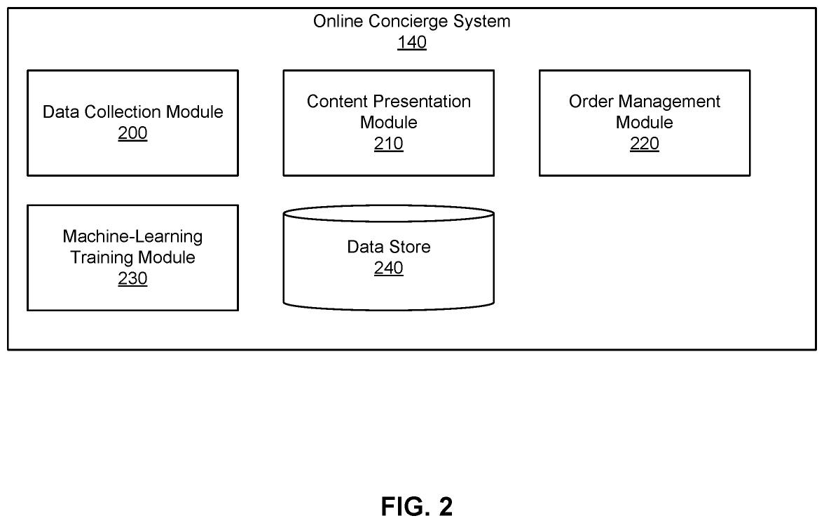

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

In various embodiments, the data collection module 200 obtains data describing combinations of items and retailers. For example, the data collection module 200 obtains information for an item identifying a date when the item was delivered to the retailer. The retailer may provide an identifier of the item and a date when the item was received by the retailer. Other information about an item may be obtained by the data collection module 200, such as an expiration date for the item. Additionally, the data collection module 200 may determine an amount of time the item has been housed at a retailer and a quantity of the item housed at the retailer.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

As further described below in conjunction with FIG. 3, the machine learning training module 230 trains a desirability model for different items. A desirability model receives attributes of an item as input and outputs a desirability score for the item indicating a suitability of the item for inclusion in an order. Attributes of the item include an expiration date of the item and one or more images of the item, from which attributes of the item are extracted. Training examples used to train the desirability model include attributes of an item and a label indicating a suitability of an item with the attributes in the training example for inclusion in an order. The machine learning training module 230 stores the trained desirability model, allowing subsequent user of the desirability model to provide notifications to a picker, to provide suggestions to a retailer, or to rank retailers for selecting a retailer to fulfill an order, as further described below in conjunction with FIGS. 3-6. In various embodiments, different desirability models are trained and stored for different items.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 is a flowchart of a method for determining a desirability score for an item based on whether the item is nearing expiration, in accordance with one or more embodiments, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

Various items offered by retailers expire over time. Different items have different expiration dates and expire at different times. However, as retailers often maintain a large number or variety of items, identifying items nearing their expiration dates is time consuming for retailers. The difficulty in identifying and replacing items nearing expiration dates increases a likelihood that a picker from an online concierge system 140 includes one or more items within a threshold amount of time from their corresponding expiration date in an order for a customer. Inclusion of such items in an order decreases customer satisfaction in order fulfillment by the online concierge system 140, reducing an amount of subsequent interaction by the customer with the online concierge system 140.

To reduce a likelihood of a picker including items within the threshold amount of time from their expiration date in an order for a customer, the online concierge system 140 obtains 305 training examples from users, such as pickers or customers. Each training example includes an identifier of an item, one or more images of an item, and a label from a user indicating whether the item is acceptable for inclusion in an order. In some embodiments, the label has a first value indicating the item is suitable for inclusion in an order and has a second, different value, indicating the item is not suitable for inclusion in the order. In other embodiments, the label has a value selected from a range of values, with different values corresponding to different levels of acceptability for including an item in an order.

In some embodiments, the online concierge system 140 obtains 305 portions of a training example from different users. For example, the online concierge system 140 receives an image of an item from a picker when the picker fulfills an order for a customer, and the online concierge system 140 receives the label for the item from a rating of the order by the customer. The online concierge system 140 determines the image of the item from an identifier of the order and the label for the item from a rating or feedback associated with the identifier of the order to generate a training example including the image of the item and the label. In various embodiments, the label is an indication the item is suitable for inclusion in an order in response to feedback from the customer that the item was a suitable replacement for another item in the order. Alternatively, the label is an indication the item is not suitable for inclusion in an order in response to feedback from the customer that the item was not a suitable replacement for another item in the order. As another example, the label is an indication the item was suitable for inclusion in an order in response to feedback from the customer that the item was a good selection by a shopper.

Inclusion of one or more images of the item in a training example allows the online concierge system 140 to extract attributes of the item from the one or more images using one or more computer vision models. In various embodiments, the online concierge system 140 maintains different computer vision models for different items or for different categories of items, and applies a computer vision model corresponding to an item or to a category of item corresponding to the training example. For example, a computer vision model for a category of item (e.g., meat) determines a color of the item from one or more images, while a computer vision model for a different category of item (e.g., produce) determines regions of the item having different colors than other regions or regions of the item having indentations or scratches from the one or more images. Maintaining different computer vision models allows the online concierge system 140 to extract different attributes of different items from their images, allowing the attributes extracted from the image to be tailored to an item or to a category of items to increase the relevance of the extracted attributes to the suitability of the item for inclusion in an order. In some embodiments, the online concierge system 140 uses an identifier of an item included in the training example to retrieve the computer vision model applied to the training example. Alternatively, the online concierge system 140 applies a classification model to the one or more images, with the classification model outputting an identifier of the item included in the training example or a category of the item included in the training example.

A training example may include additional attributes of an item in various embodiments. For example, a training example includes an expiration date of the item. In some embodiments, a user who captured the image of the item also identifies the expiration date of the item. Alternatively, the online concierge system 140 determines the expiration date of the item from information received from a retailer. For example, a user specifies a retailer where an image of the item was captured and a date when the image of the item was captured along with the image of the item. From the identifier of the item (determined from the image or received in conjunction with the image) and the specified retailer, the online concierge system 140 retrieves information associated with the retailer (or from the retailer) identifying a specified expiration date of the item. In other embodiments, the online concierge system 140 extracts an expiration date of the item from the image of the item.

In some embodiments, the online concierge system 140 also determines a shelf warming life for an item included in a training example. The shelf warming life of the item measures an amount of time the item has been available at the retailer. For example, the online concierge system 140 determines the shelf warming life for an item included in a training example based on an identifier of a retailer, an identifier of the item, and a time when the training example was obtained 305. As an example, the online concierge system 140 retrieves data from a retailer (or associated with a retailer) indicating a date when the retailer most recently received the item and determines the shelf warming life for the item of the training example based on a difference between the date when the retailer most recently received the item and a date when the online concierge system 140 obtained the image of the item of the training example. The shelf warming life allows the online concierge system 140 to account for a length of time that the retailer has stored or has offered the item.

Thus, in various embodiments, the online concierge system 140 leverages stored information about an item or information about the item from other sources to include additional attributes of the item in a training example to augment the one or more images of the item and the label indicating whether the item is suitable for inclusion in an order. The additional information augments attributes of the item determined from the one or more images of the item, providing additional information about an age of the item relative to its expiration data. Further, the additional information allows the online concierge system 140 to better determine an expiration date for the item and to account for a length of time the item has been offered by or stored by the retailer.

Using a set of obtained training examples for an item, the online concierge system 140 trains 310 a desirability model for the item. The desirability model receives attributes of the item as inputs and outputs a desirability score for the item. The desirability score provides a likelihood of the item being suitable for inclusion in an order based on the attributes of the item. In some embodiments, the desirability score is binary, having a first value indicating the item is suitable for inclusion in an order and having a second value indicating the item is not suitable for inclusion in an order. Alternatively, the desirability score has a range of values, with different values indicating different levels of the item's suitability for inclusion in an order. For example, higher values of the desirability score correspond to higher suitability for inclusion in an order, while lower values of the desirability score correspond to lower suitability for inclusion in an order.

The desirability model comprises a set of weights stored on a non-transitory computer readable storage medium in various embodiments. The weights comprise a set of parameters used by the desirability model to transform input data—the attributes of the item-received by the desirability model into output data—the desirability score. The online concierge system 140 generates the weights by applying the desirability model to a set of training examples, with a label associated with each training example. Application of the desirability model to a training example generates a predicted desirability score for an item included in the training example. The online concierge system 140 compares the predicted desirability score for the training example to a label associated with the training example. In various embodiments, the online concierge system 140 scores the predicted desirability score from the desirability model using a loss function. A loss function is a function that generates a score for the predicted desirability score where the score is higher when the predicted desirability score is nearer to the label of the training example, while the score is lower when the predicted desirability score is farther from the label of the training example. Hence, the score is based on a difference between the predicted desirability score for a training example and a label for the training example, with the loss function determining the score. Example loss functions include a mean square error function, a mean absolute error, a hinge loss function, and a cross-entropy loss function. The online concierge system 140 updates the set of parameters for the desirability model based on the score for the training example through a backpropagation process. For example, the online concierge system 140 may apply gradient descent to update the set of parameters. In various embodiments, the online concierge system 140 performs the backpropagation process until the loss function satisfies one or more criteria, and stores the set of parameters.

The online concierge system 140 stores 315 the trained desirability model in association with the item. In various embodiments, the online concierge system 140 trains 310 and stores 315 different desirability models in association with different items. As different attributes of different items affect a desirability of including different items, training 310 and storing 315 different trained desirability models for different items allows the online concierge system 140 to account for differences in attributes of items that affect suitability of different items for inclusion in orders. Further, in some embodiments, the online concierge system 140 periodically retrains a desirability model using updated training examples and stores 315 the updated desirability model, allowing the desirability model to account for changes in how attributes of an item affect suitability of the item for inclusion in an order.

In various embodiments, the online concierge system 140 uses a stored desirability model for an item to provide additional information to a picker fulfilling an order. For example, the online concierge system 140 receives 320 one or more additional images of the item from a picker fulfilling an order for a customer via a picker client device 110. An additional image of the item is an image of the item that is not included in a training example. In some embodiments, the online concierge system 140 receives an identifier of the item along with the one or more additional images, while in other embodiments the online concierge system 140 applies a classification model to the one or more additional images to determine an identifier for the item. The online concierge system 140 retrieves a trained desirability model for the item (e.g., a trained desirability model stored in association with the identifier of the item) and determines 325 a desirability score for the item by applying the trained desirability model for the item to the one or more additional images of the item. In various embodiments, the online concierge system 140 extracts attributes of the item from one or more additional images and applies the desirability model for the item to the extracted attributes to determine 325 the desirability score for the item. Further, in some embodiments, the online concierge system 140 obtains additional attributes of the item, as further described above, and applies the desirability model for the item to attributes extracted from the one or more additional images and the additional attributes to determine 325 the desirability score for the item.

Based on the determined desirability score, the online concierge system 140 determines and transmits 330 one or more notifications to a picker client device 110 for presentation to the picker. For example, a notification is a message to the picker that the item is suitable for inclusion in the order in response to the desirability score having a particular value or having at least a threshold value. As another example, the notification is a message to the picker that the item is not suitable for inclusion in the order in response to desirability score having an alternative value or having less than the threshold value. The picker client device 110 displays the notification to the picker through an interface.

In various embodiments, a notification transmitted 330 to the picker client device for presentation to the picker accounts for the order being fulfilled by the picker. For example, the order is based on a recipe maintained by the online concierge system 140, and the online concierge system 140 accounts for attributes of items for the recipe. As an example, certain recipes specify items near their expiration date (e.g., ripe or overripe produce). The online concierge system 140 determines the threshold desirability score or a range of desirability scores for the item from the recipe (e.g., from tags associated with the recipe or from content included in the recipe) and determines a message for a shopper based on the desirability score determined for the item and the threshold desirability score of the item or the range of desirability scores of the item determined from the recipe. For example, if a recipe specifies a ripe item, the online concierge system 140 transmits 330 a notification to the picker client device indicating inclusion of an item in the order in response to the desirability score of the item being lower than a specified threshold, with the threshold for the item corresponding to a ripeness of the item specified by the recipe. For example, overripe bananas are suitable for a banana bread recipe, so the notification transmitted 330 to the picker shopper client device accounts for the ripeness of the bananas in the recipe based on an image of a banana and prompts the shopper to include a banana with a lower desirability score in an order based on the banana bread recipe, while the lower desirability score would correspond to the banana not being included in an order not based on the banana bread recipe. Hence, notifications from the online concierge system 140 account for attributes of items in a recipe when determining a threshold desirability score or a range of desirability scores prompting a notification to include the item in an order, allowing certain orders to include items with lower desirability scores based on attributes of items that are suitable for use in the recipe on which the order is based. This allows pickers to more efficiently use a retailer's stock of items by identifying when items with lower desirability scores are suitable for inclusion in orders.

Additionally or alternatively, the online concierge system 140 determines a threshold value for a desirability score corresponding to a notification to include the item in an order (or a range of desirability scores for a notification to include the item in an order) based on a customer associated with the order and a category including the item. A customer may have different preferences or tolerances for time intervals until an expiration date for items in different categories. In various embodiments, the online concierge system 140 determines the customer's tolerances for time until an expiration date based on prior orders fulfilled for the customer. For example, the online concierge system 140 determines desirability scores for items in orders for the customer and determines a user's sensitivity for time until item expiration dates based on user feedback for the orders. For a category of items, the online concierge system 140 determines a threshold desirability score for the category based on an aggregation (e.g., average) of desirability scores for items in the category included in orders for which the customer provided positive feedback. The online concierge system 140 stores a threshold desirability score for the category in association with the customer, allowing the online concierge system 140 to account for the customer's sensitivity to a time until an item's expiration date for the category in subsequent orders. Maintaining threshold desirability scores for combinations of categories of items and users allows the online concierge system 140 to determine a notification for transmitting 330 to a picker that accounts for the particular user's sensitivity to a time until an expiration date for an item in a particular category. This allows the online concierge system 140 to transmit 330 notifications to pickers that are personalized for a customer whose order is being fulfilled, increasing a likelihood of the picker including items in the order that the customer considers satisfactory.

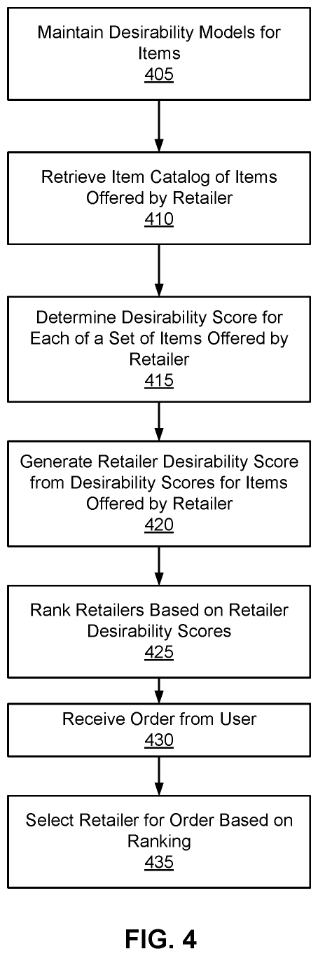

The online concierge system 140 may use stored desirability models associated with items in other ways. For example, FIG. 4 is a flowchart of a method for selecting a retailer for an order based on desirability scores for items by retailers, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., online concierge system 140). Additionally, each of these steps may be performed automatically by the online concierge system 140 without human intervention.

As further described above in conjunction with FIG. 3, the online concierge system 140 maintains 405 desirability models for different items offered by one or more retailers. Training of a desirability model is further described above in conjunction with FIG. 3. As further described above in conjunction with FIG. 3, the online concierge system 140 trains and maintains 405 desirability models for different items to account for variations in effects of attributes of different items on suitability of inclusion of items in orders.

As different retailers may have inventories of items having different amounts of time until their respective expiration dates, pickers fulfilling orders at different retailers have different likelihoods of obtaining items for orders having appropriate lengths of time from their expiration dates. For example, a first retailer has an inventory of produce with less than a threshold amount of time from its expiration date, while a second retailer has an inventory of produce that more recently arrived at the second retailer, so produce at the second retailer has a higher likelihood of being suitable for inclusion in orders than produce at the first retailer. Such differences in suitability of items for orders by different retailers causes the retailer selected for fulfilling an order to affect a picker's ability to fulfill an order to a customer's satisfaction.

To account for differences in suitability of items for orders by different retailers, the online concierge system 140 retrieves 410 an item catalog of items offered by a retailer. The online concierge system 140 determines 415 a desirability score for each of at least a set of items offered by the retailer by applying a corresponding desirability model to attributes of an item of the set, as further described above in conjunction with FIG. 3. In some embodiments, the online concierge system 140 determines 415 a desirability score for each item in the item catalog offered by the retailer for which the online concierge system 140 maintains 405 a desirability model.

The online concierge system 140 generates 420 a retailer desirability score for the retailer by aggregating the desirability scores determined 415 for each item of the set for the retailer. In some embodiments, the retailer desirability score for the retailer is an average of the desirability scores determined 415 for items of the set for the retailer. However, in other embodiments, the online concierge system 140 generates 420 the retailer desirability score from other aggregations of the determined desirability scores (e.g., a median desirability score, a mode desirability score, etc.).

In some embodiments, the online concierge system 140 retrieves a taxonomy of items offered by the retailer and determines categories for different items offered by the retailer. The online concierge system 140 determines one or more category-specific retailer desirability scores for the retailer from the taxonomy of items and the desirability scores for items offered by the retailer. For example, the online concierge system 140 generates 420 a category-specific retailer desirability score for a category by aggregating desirability scores determined for items in the category offered by the retailer. In some embodiments, the category-specific retailer desirability score is determined as an average desirability score for items of the category offered by the retailer. However, in other embodiments, the online concierge system 140 generates 420 the category-specific retailer desirability score from other aggregations of the determined desirability scores (e.g., a median desirability score, a mode desirability score, etc.) for items of the category.

The online concierge system 140 ranks 425 retailers based on their retailer desirability scores. Retailers having higher retailer desirability scores have higher positions in the ranking in various embodiments. In embodiments where the online concierge system 140 generates 420 category-specific retailer desirability scores, the online concierge system 140 determines category-specific rankings of retailers for different categories. Retailers with higher category-specific retailer rankings for a category have higher positions in a category-specific ranking for the category. Hence, in some embodiments, the online concierge system 140 maintains different rankings of retailers for different categories based on their category-specific desirability scores, allowing the ranking 425 of retailers to account for differences in desirability scores for items in different categories for different retailers. For example, category-specific ranking 425 of retailers may result in a retailer having a higher position for a category-specific ranking for one category and a lower position for a category-specific ranking for a different category.

When the online concierge system 140 receives 430 an order from a user, the online concierge system 140 selects 435 a retailer for fulfilling the order based on items included in the order and the ranking based on retailer desirability scores (or based on category-specific rankings of retailers from category-specific retailer desirability scores). In some embodiments, the online concierge system 140 presents a notification to a customer from whom an order was received 430 about an alternative retailer for fulfilling the order in response to the online concierge system 140 determines the alternative retailer has a higher position in the ranking of retailers (or in a category-specific ranking including one or more items in the order) than a retailer identified by the order. For example, in response to an alternative retailer having a higher position in the ranking by at least a threshold amount than a retailer specified by the customer, the online concierge system 140 presents the notification identifying the alternative retailer to the customer via an interface on a customer client device 110. The customer may modify the order to be fulfilled by the alternative retailer by providing one or more inputs to the online concierge system 140 through the customer client device 110. In some embodiments, the alternative retailer is an alternative location of a retailer selected for fulfilling the order. In response to the alternative retailer having a greater distance from the customer's location specified by the order, the online concierge system 140 applies an additional charge for fulfilling the order to account for increased travel. The notification identifying the alternative retailer identifies the additional charge to the customer, allowing the customer to approve or deny using the alternative retailer and incurring the additional charge for order fulfillment. In some embodiments, if the alternative retailer is within a threshold distance of the customer's location, the online concierge system 140 selects 430 the alternative retailer without transmitting a notification to the user and without applying an additional charge to the order.

Additionally or alternatively, the online concierge system 140 leverages desirability scores for items to provide recommendations to a retailer for managing item inventory. FIG. 5 is a flowchart of a method for an online concierge system 140 providing recommendations to a retailer based on desirability scores of items offered by the retailer, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system 140 without human intervention.

As further described above in conjunction with FIG. 3, the online concierge system 140 maintains 505 desirability models for different items offered by one or more retailers. Generation and training of a desirability model is further described above in conjunction with FIG. 3. As further described above in conjunction with FIG. 3, the online concierge system 140 trains and maintains 505 desirability models for different items to account for variations in effects of attributes of different items on suitability of inclusion of items in orders.

In various embodiments, the online concierge system 140 receives 510 one or more images of an item from a retailer computing system 120. The online concierge system 140 receives 510 the one or more images of the item along with an identifier of the item and an identifier of the retailer in some embodiments. Alternatively, the online concierge system 140 receives 510 one or more images of the item and an identifier of the retailer, and the online concierge system determines the identifier of the item by applying one or more classification models to the one or more images. An associate or an employee of the retailer captures the one or more images of the item through a client device that communicates the one or more images to the online concierge system 140 or to the retailer computing system 120 in various embodiments.

The online concierge system 140 determines 515 a desirability score for the item by applying the desirability model for the item to the one or more images of the item and other attributes of the item. Determination 515 of the desirability score from application of the desirability model is further described above in conjunction with FIG. 3. Based on the desirability score for the item, the online concierge system 140 generates 520 one or more suggestions for the item.

In various embodiments, the online concierge system 140 generates 520 a suggestion by comparing the desirability score for the item to ranges of desirability scores, with each range associated with a suggestion. In some embodiments, a range of desirability scores is associated with a suggestion for the retailer to offer an item at a discount. The discount for the item may be inversely related to the desirability score of the item, with lower desirability scores having larger discounts and higher desirability scores having smaller discounts, in some embodiments, with the suggestion specifying the discount in association with the item. Alternatively, the discount is a fixed amount for different desirability scores. In some embodiments, a suggestion to discount the item also includes a recommendation to reposition the item's location within the retailer to a different location (e.g., moving the item from a primary display location to a clearance display location). Another range of desirability scores is associated with a suggestion to donate the item. An alternative range of desirability scores is associated with a suggestion to move the item to an alternate location of the retailer to increase a likelihood of the item being sold. An additional range of desirability scores is associated with a suggestion to offer a promotion for the item. In some embodiments, the online concierge system 140 generates 520 multiple suggestions to provide alternative actions for a retailer to take relative to the item.

The online concierge system 140 transmits 525 the generated suggestion to a retailer computing system 120 for presentation to one or more users at the retailer. In various embodiments, the online concierge system 140 transmits information identifying the item (e.g., an item name, an item image, an item description) along with the suggestion, allowing the user at the retailer to evaluate whether to implement the suggestion. In various embodiments, the suggestion is displayed as a notification or a message via an interface of the retailer computing system 120. This allows the online concierge system 140 to leverage stored desirability models for different items to provide suggestions for one or more actions for a retailer to perform for an item to increase a likelihood of the item being sold or otherwise used prior to its expiration date based on the amount of time until the item reaches its expiration date.

The online concierge system 140 may identify retailers having greater than a threshold number or a threshold amount of items having less than a threshold desirability score in some embodiments. As items having lower desirability scores are items nearing or past their expiration dates, identifying a retailer with at least the threshold number or the threshold amount of items with less than the threshold desirability score allows the online concierge system 140 to provide information about performance of a retailer and insight into quality of items received by retailers. For example, the online concierge system 140 identifies a location of a retailer having greater than a threshold amount of items with less than the threshold desirability score and transmits a notification identifying the location to the retailer, allowing the retailer to obtain additional information about the location. Additionally, identifying a location of a retailer having greater than a threshold amount of items with less than the threshold desirability score to the retailer provides the retailer with an indication to evaluate a provider of items with having less than the threshold desirability score or to evaluate a supply line from the provider for the retailer to ascertain why the location has at least the threshold amount of the item with less than the threshold desirability score. Such information allows a retailer to more quickly identify potential issues with how the item is supplied to or is maintained by the location.

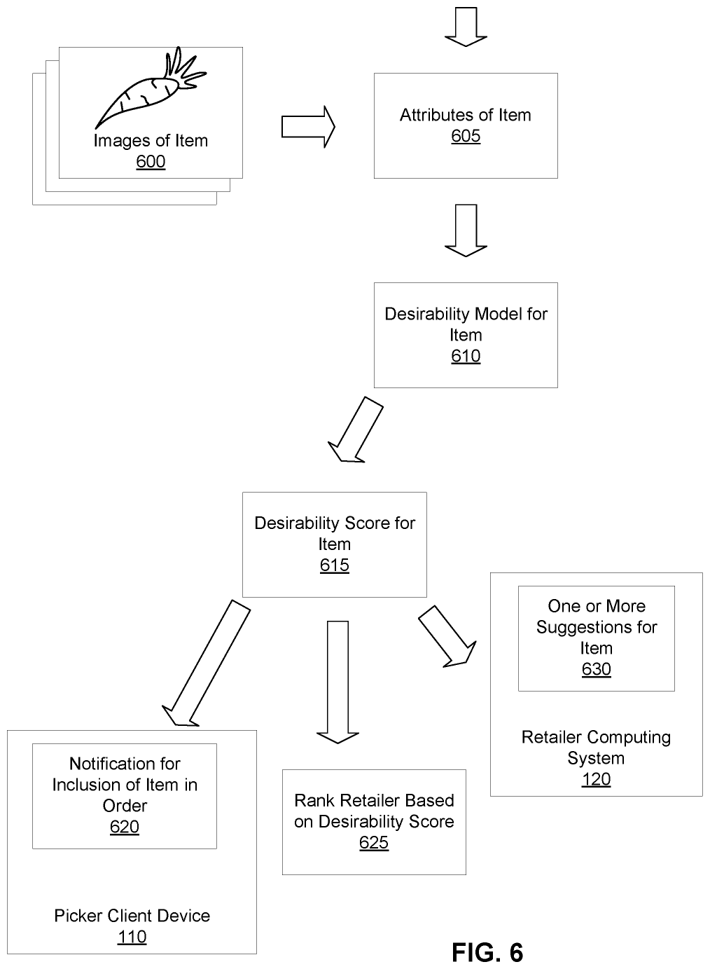

As further described above in conjunction with FIGS. 3-5, training and maintaining a desirability model for different items allows the online concierge system 140 to provide notifications for shoppers, to provide suggestions for retailers, to select a retailer for fulfilling an order based on desirability scores determined for items offered by retailers. As the desirability score that was determined for an item accounts for an amount of time between a time when the desirability score is determined to an expiration date of the item, the desirability score allows the online concierge system 140 to perform or to suggest actions that reduce a likelihood of a customer receiving an item within a threshold amount of time from its expiration date when the online concierge system 140 fulfills an order from the customer. FIG. 6 is a process flow diagram of an online concierge system 140 performing one or more actions based on a desirability score determined for an item. The online concierge system 140 may perform multiple actions further described below in conjunction with FIG. 6 or may perform different actions described below in conjunction with FIG. 6 at different times in various embodiments.

The online concierge system 140 receives one or more images 600 of an item offered by a retailer. In some embodiments, the images are captured by a picker client device 110 of a picker fulfilling an order in a retailer. Alternatively, the images are captured by a retailer computing system 120 of the retailer or by a client device of an associate of the retailer. In other embodiments, the one or more images 600 are received from a customer client device 100. The online concierge system 140 also receives an identifier of the item in association with the one or more images 600 in some embodiments.

Through application of one or more computer vision models to the one or more images, the online concierge system 140 determines attributes 605 of the item from the one or more images 600 of the item. In various embodiments, the online concierge system 140 maintains different computer vision models for different items, with a computer vision model for an item configured to extract attributes specific to the item from one or more images of the item. The online concierge system 140 determines one or more computer vision models for application to the one or more images 600 of the item from an identifier of the item received with the one or more images of the item in some embodiments. In other embodiments, the online concierge system 140 applies a classification model to the one or more images 600 of the item to determine an identifier for the item then retrieves one or more computer vision models based on the identifier for the item. For example, a computer vision model for a meat item identifies a color of the item from the images 600 of the item, while a computer vision module for a produce item identifies color differences between different portions of the item and identifies scratches or indentations on the item from the one or more images 600. Hence, different computer vision models allow the online concierge system 140 to extract item-specific attributes 605 from the one or more images 600 of the item.

Additionally, the online concierge system 140 may obtain additional attributes 605 of the item to augment the attributes 605 determined from the one or more images 600. For example, the online concierge system 140 obtains an expiration date of the item from a picker, customer, or retailer associate. As another example, the online concierge system 140 obtains an identifier of a retailer corresponding to the one or more images 600 of the item and determines when a most recent delivery of the item to the retailer occurred. From the most recent delivery of the item to the retailer and a date when the one or more images 600 of the item were received, the online concierge system 140 determines a shelf warming life of the item. As another example, the online concierge system 140 determines a shelf life of the item from information stored by the retailer or provided to the online concierge system 140 by the retailer, with the shelf-life specifying an amount of time the item remains unexpired when stored. In various embodiments, the online concierge system 140 obtains different attributes 605 for different items.

The online concierge system 140 retrieves a desirability model 610 for the item and applies the desirability model to the attributes 605 of the item to determine a desirability score 615 for the item. As further described above in conjunction with FIG. 3, the online concierge system 140 trains and stores the desirability model 610 based on labeled training examples including attributes 605 of the item. The online concierge system 140 trains and stores different desirability models 610 for different items, allowing the online concierge system 140 to account for different attributes of different items or to differently weight attributes of different items when determining a desirability score 615 for an item. As further described above in conjunction with FIG. 3, the desirability score 615 for an item provides a likelihood of the item being suitable for inclusion in an order based on the attributes 605 of the item. As the desirability model 610 determines the desirability score 615 based on attributes 605 of the item including the item's expiration date, the desirability score 615 accounts for a condition of the item (determined from the attributes 605 of the item) and an amount of time until the item's expiration date.

In some embodiments, the online concierge system 140 receives the images 600 of the item from a picker client device 110. For example, when fulfilling an order for a customer, the picker transmits one or more images 600 of the item to the online concierge system 140 to determine whether the item is suitable for inclusion in the order. Based on the desirability score 615 determined for the item, the online concierge system 140 generates a notification 620 for the picker, with the notification 620 providing an indication of the suitability of the item for inclusion in the order. As further described above in conjunction with FIG. 3, the online concierge system 140 maintains different notifications for different ranges of desirability scores or for different desirability scores. The online concierge system 140 transmits the notification 620 based on the desirability score 615 to the picker client device 110 to provide the picker with feedback regarding whether to include the item in the order.

Alternatively or additionally, the online concierge system 140 determines a retailer desirability score for a retailer that accounts for the desirability score 615 for the item. For example, the online concierge system 140 aggregates the desirability score 615 for the item and desirability scores for other items offered by the retailer to determine a retailer desirability score, as further described above in conjunction with FIG. 4. In some embodiments, the online concierge system 140 ranks 625 the retailer relative to other retailers based on retailer desirability scores for different retailers. When the online concierge system 140 receives an order, the online concierge system 140 may select a retailer for fulfilling the order, or identify potential retailers for fulfilling the order to a customer, based on the ranking based on retailer desirability scores. This allows the online concierge system 140 to account for an amount of time between receipt of the order and expiration dates of items included in the order when selecting a retailer for fulfilling the order to select a retailer for fulfilling the order that has relatively higher desirability scores for items. Selecting a retailer for fulfilling an order based on retailer desirability scores allows the online concierge system 140 to increase a likelihood of the order being fulfilled by selecting a retailer having items at least a threshold amount of time from their respective expiration dates.

Further, in some embodiments, the online concierge system 140 leverages the desirability score 615 for the item to determine one or more suggestions 630 for the retailer. A suggestion includes information for performing one or more actions relative to the item. For example, a suggestion identifies one or more actions for marketing the item to customers. The actions specified by a suggestion increase a likelihood of the item being sold or being used before its expiration date. For example, in response to receiving the one or more images 600 of the item form a retailer computing system 120 (or from a client device associated with the retailer), the online concierge system 140 determines a suggestion 630 for the item based on the desirability score 615 determined for the item. As further described above in conjunction with FIG. 5, the online concierge system 140 maintains different suggestions for different ranges of desirability scores or for different desirability scores. Example actions specified by suggestions include discounting the item, moving the item to another location within the retailer, moving the item to another retailer, donating the item, or other actions to increase a likelihood of the item being used before its expiration date. In some embodiments, the online concierge system 140 stores suggestions in association with a category of the item and a desirability score, allowing the online concierge system 140 to determine different suggestions for items in different categories with a common desirability score. The online concierge system 140 transmits the suggestion 630 for the item to the retailer computing system 120 to identify one or more actions to the retailer to minimize an amount of the item that the retailer has in stock.

By training and storing a desirability model 610 for different items, the online concierge system 140 accounts for an amount of time until an item's expiration date to optimize use of the item. For example, the desirability score for an item allows the online concierge system 140 to provide notifications to pickers that reduce a likelihood of a picker including an item within a threshold amount of time of its expiration date in an order, increasing a customer's satisfaction with the order. Leveraging the desirability scores for multiple items to determine a retailer desirability score allows the online concierge system 140 to select a retailer for fulfilling an order that is most likely to have items in the order that are greater than a threshold amount of time from their expiration dates. Additionally, the online concierge system 140 may use a desirability score for an item to provide suggestions for marketing or for using the item to a retailer that minimizes an amount of inventory of the item within the threshold amount of time from its expiration date maintained by the retailer. Hence, a desirability score for an item allows the online concierge system 140 to perform actions relative to the item that account for a condition of an item relative to its expiration date to increase customer satisfaction with orders and to allow retailers to more efficiently use or distribute their inventory of the item before its expiration date.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program item comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program item or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable storage medium:
receiving images of an item offered by a retailer;
training a desirability model based on attributes of the item offered by the retailer by:
obtaining a set of training examples, each training example including attributes of the item offered by the retailer, one or more attributes determined from a received image of the item, and each training example having a label indicating whether the item is acceptable for inclusion in an order;
applying the desirability model to each training example of the set to generated a predicted desirability score for the training example;
scoring the predicted desirability score for the training example using a loss function and the label of the training example; and
updating one or more parameters of the desirability model by backpropagation based on the scoring;
storing, in the computer readable storage medium, the desirability model in association with the item offered by the retailer; and
applying the trained desirability model to give feedback about an instance of the item offered by the retailer.

2. The method of claim 1, wherein applying the trained desirability model to give feedback about an instance of the item offered by the retailer comprises:
receiving, at the computer system, one or more additional images of the item from a picker client device;
retrieving the desirability model;
determining, using the desirability model, a desirability score for the item based on attributes of the item, one or more of the attributes determined from the one or more additional images of the item; and
transmitting a notification from the computer system to the picker client device, the notification based on the desirability score for the item and comprising a message indicating whether the item is suitable for inclusion in the order.

3. The method of claim 2, wherein the notification comprises a message that the item is suitable for inclusion in the order in response to the desirability score having at least a threshold value.

4. The method of claim 3, wherein the notification comprises a message that the item is not suitable for inclusion in the order in response to desirability score having less than the threshold value.

5. The method of claim 3, wherein the threshold value is based on a customer associated with the order and a category including the item.

6. The method of claim 1, wherein applying the trained desirability model to give feedback about an instance of the item offered by the retailer comprises:
retrieving an item catalog of items offered by a retailer;
determining, using the desirability model, a desirability score for the item based on attributes of the item from the retailer;
determining desirability scores for each item of a set of items from the item catalog using desirability models stored in association with the items of the set; and
generating a retailer desirability score for the retailer from the desirability score for the item and the desirability scores for each item of the set of items.

7. The method of claim 6, further comprising:
ranking the retailer relative to other retailers in a ranking based on the retailer desirability score for the retailer and retailer desirability scores for the other retailers.

8. The method of claim 7, further comprising:
selecting a retailer for fulfilling an order based on the ranking.

9. The method of claim 1, wherein applying the trained desirability model to give feedback about an instance of the item offered by the retailer comprises:
receiving, at the computer system, one or more additional images of the item from a retailer computer system;
retrieving the desirability model;
determining, using the desirability model, a desirability score for the item based on attributes of the item, one or more of the attributes determined from the one or more additional images of the item;
generating a suggestion for the item based on the desirability score for the item; and
transmitting the suggestion from the computer system to the retailer computer system.

10. The method of claim 9, wherein the suggestion specifies the retailer offering the item at a discount in response to the desirability score for the item being in a range of desirability scores.

11. A computer program product comprising a non-transitory computer readable storage medium having instructions encoded thereon that, when executed by a processor, cause the processor to perform steps comprising:
receiving images of an item offered by a retailer;
training a desirability model based on attributes of the item offered by the retailer by:
obtaining a set of training examples, each training example including attributes of the item offered by the retailer, one or more attributes determined from a received image of the item, and each training example having a label indicating whether the item is acceptable for inclusion in an order;
applying the desirability model to each training example of the set to generated a predicted desirability score for the training example;
scoring the predicted desirability score for the training example using a loss function and the label of the training example; and
updating one or more parameters of the desirability model by backpropagation based on the scoring;
storing, in the computer readable storage medium, the desirability model in association with the item offered by the retailer; and
applying the trained desirability model to give feedback about an instance of the item offered by the retailer.

12. The computer program product of claim 11, wherein applying the trained desirability model to give feedback about an instance of the item offered by the retailer comprises:
receiving one or more additional images of the item from a picker client device;
retrieving the desirability model;
determining, using the desirability model, a desirability score for the item based on attributes of the item, one or more of the attributes determined from the one or more additional images of the item; and
transmitting a notification to the picker client device, the notification based on the desirability score for the item and comprising a message indicating whether the item is suitable for inclusion in the order.

13. The computer program product of claim 12, wherein the notification comprises a message that the item is suitable for inclusion in the order in response to the desirability score having at least a threshold value.

14. The computer program product of claim 13, wherein the threshold value is based on a customer associated with the order and a category including the item.

15. The computer program product of claim 11, wherein applying the trained desirability model to give feedback about an instance of the item offered by the retailer comprises:
retrieving an item catalog of items offered by a retailer;
determining, using the desirability model, a desirability score for the item based on attributes of the item from the retailer;
determining desirability scores for each item of a set of items from the item catalog using desirability models stored in association with the items of the set; and
generating a retailer desirability score for the retailer from the desirability score for the item and the desirability scores for each item of the set of items.

16. The computer program product of claim 15, wherein the non-transitory computer readable storage medium further has instructions encoded thereon that, when executed by the processor, cause the processor to perform steps comprising:
ranking the retailer relative to other retailers in a ranking based on the retailer desirability score for the retailer and retailer desirability scores for the other retailers.

17. The computer program product of claim 16, wherein the non-transitory computer readable storage medium further has instructions encoded thereon that, when executed by the processor, cause the processor to perform steps comprising:
selecting a retailer for fulfilling an order based on the ranking.

18. The computer program product of claim 11, wherein applying the trained desirability model to give feedback about an instance of the item offered by the retailer comprises:
receiving one or more additional images of the item from a retailer computer system;
retrieving the desirability model;
determining, using the desirability model, a desirability score for the item based on attributes of the item, one or more of the attributes determined from the one or more additional images of the item;
generating a suggestion for the item based on the desirability score for the item; and
transmitting the suggestion from the computer system to the retailer computer system.

19. A system comprising:
one or more processors; and
a non-transitory computer readable storage medium having instructions encoded thereon that, when executed by the one or more processors, cause the one or more processor to perform steps comprising:
receiving images of an item offered by a retailer;
training a desirability model based on attributes of the item offered by the retailer by:
obtaining a set of training examples, each training example including attributes of the item offered by the retailer, one or more attributes determined from a received image of the item, and each training example having a label indicating whether the item is acceptable for inclusion in an order;
applying the desirability model to each training example of the set to generated a predicted desirability score for the training example;
scoring the predicted desirability score for the training example using a loss function and the label of the training example; and
updating one or more parameters of the desirability model by backpropagation based on the scoring;
storing, in the computer readable storage medium, the desirability model in association with the item offered by the retailer; and
applying the trained desirability model to give feedback about an instance of the item offered by the retailer.

20. The system of claim 19, wherein applying the trained desirability model to give feedback about an instance of the item offered by the retailer comprises:
receiving, at the computer system, one or more additional images of the item from a picker client device;
retrieving the desirability model;
determining, using the desirability model, a desirability score for the item based on attributes of the item, one or more of the attributes determined from the one or more additional images of the item; and
transmitting a notification from the computer system to the picker client device, the notification based on the desirability score for the item and comprising a message indicating whether the item is suitable for inclusion in the order.
